(19) United States
(12) Patent Application Publication
(10) Pub. No.: US 2006/0087419 A1
(43) Pub. Date: Apr. 27, 2006

(54) Tire safety monitoring GPS display device

(76) Inventor: Ta-Min Peng, Taoyuan (TW)

Correspondence Address: C.Q.S. Technologies Inc., P.O. Box No. 6-57, Junghe, Taipei 235, TW

(21) Appl. No.: 10/968,877

(22) Filed: Oct. 21, 2004

(51) Int. Cl. B60C 23/00; G01M 17/00; G08G 1/123

(52) U.S. Cl. 340/445; 340/995.24; 340/995.27; 701/29

(57) ABSTRACT

A tire safety monitoring GPS display device includes a contact surface of a sensor joined to a tire steel ring by means of a circular fitting fixing agent, and the sensor is fixed onto the tire steel ring hereof. When the sensor circuit interior of the sensor detects internal status of a tire, the transmitting circuit transmits data to an aerial, and further transmits to a main receiver, whereupon status regarding interior of the tire is displayed on a screen of the main receiver. If an anomaly occurs, a communications module transmits a singal to the GPS receiver, at which time displaying on a monitor a car repair workshop at a closest distance from vehicle. Furthermore, if unusual movement in position of the vehicle occurs, the sensor transmits data to the GPS receiver thereby notifying location of the vehicle to a mobile communications device used by a user.

### BACKGROUND OF THE INVENTION

(a) Field of the Invention

The present invention relates to a tire safety monitoring GPS display device having structural characteristics whereby a contact surface of a sensor is joined to a surface of a tire steel ring by means of a circular fitting fixing agent, and the sensor is securely fixed onto the steel ring of a tire thereof.

(b) Description of the Prior Art

Referring to FIG. 1, which shows a conventional method for measuring vehicle tire pressure, whereby a tire pressure gauge B is inserted onto an inflation nozzle A1 of a tire A, thereby enabling measuring of internal air pressure of the tire A. However, when a user wishes to measure the tire pressure, the user must stop the moving vehicle by the roadside in order to carry out the measurement. Furthermore, after the vehicle has been driving for a long period of time, in order to measure amount of change in the pressure of vehicle tires, the vehicle must be first stopped before the measurement can be carried out. Such a procedure is not only troublesome; moreover, traffic accidents easily result as a consequence of such a course of action.

In addition, a traditional tire pressure gauge is only able to measure pressure of the tire, and does not have functionality of real-time reporting and real-time measurement of status of the vehicle tires and thus, when a driver is driving the vehicle, accidents can easily occur because of insufficient tire pressure.

Hence, the inventor of the present invention proposes to resolve and surmount existent technical difficulties to eliminate the aforementioned shortcomings.

### SUMMARY OF THE INVENTION

The present invention provides a tire safety monitoring GPS display device, and referring to FIGS. 2, 3 and 4 which show the present invention structured to comprise a sensor C, a belt C1, a main receiver D and a GPS receiver E, wherein an aerial C4, a sensor circuit C5 and a transmitting circuit C6 are configured on a circuit board C7 interior of the sensor C (see FIG. 3).

The present invention (with additional reference to FIG. 5) is structurally characterized in that: a contact surface C8 of the sensor C is joined to a surface of a tire steel ring H by means of a circular fitting fixing agent C9, and an inflation nozzle H1 of the tire steel ring H penetrates a through hole C3 of the sensor C, and after the belt C1 is made to pass through a through hole C2 of the sensor C, the sensor C is thereupon securely fixed onto the tire steel ring H therewith. Furthermore, an arc-shaped form of the contact surface C8 is utilized to effectuate tight adhering of the sensor C to a surface of the tire steel ring H.

When the sensor circuit C5 interior of the sensor C detects pressure and temperature interior of a tire, the transmitting circuit C6 transmits data to the aerial C4, and thereon a wireless signal carrying the data is transmitted to the main receiver D (see FIG. 4), whereupon status regarding the pressure and temperature interior of the tire is displayed on a screen of the main receiver D. If there is a situation whereby insufficient vehicle tire pressure or too high a vehicle tire pressure occurs, a communications module D3 transmits communication F to the GPS receiver E, whereby method employed to transmit the communication F from the communications module D3 is either through a wireless mode of the aerial D1 or a wired mode of a connector port D2 according to choice of a user. The GPS receiver E is correspondingly configured with an aerial E1 to receive the signal communication F from (the main receiver D or receives the signal communication F from the main receiver D through a connector port E2, at which time the GPS receiver E displays on a monitor a car repair workshop and a tire inflation station at a closest distance from vehicle, thereby informing the user how to proceed toward the workshop in order to service the vehicle tire, and thus preventing an accident from occurring.

Furthermore, if after parking the vehicle, the vehicle happens to be moved, the sensor C detects that displacement of the vehicle tires has occurred, and transmits a signal to the main receiver D, and upon the main receiver D receiving the signal from the displaced tires, the communications module D3 transmits a wireless signal to the GPS receiver E employing the wireless mode from the aerial D1 or transmits wired data to the GPS receiver E employing the wired mode from the connector port, D2 according to choice of the user, and therefrom transmits location of the vehicle to a mobile communications device or a PDA (Personal Digital Assistant) used by the user by means of a communications module E3 built into the GPS receiver E that employs communication methods including GPS (Global Positioning System), GPRS (General Packet Radio Service), CDMA (Code Division Multiple Access) or GSM (Global System for Mobile Communications), thereby informing the user that the vehicle has been moved, and thus achieving effectiveness of providing a theft alarm and tracing theft of the vehicle.

Communication methods adopted by the main receiver D and the GPS receiver E to transmit signals include wireless signal transmission methods employed by wireless Bluetooth, FM (frequency modulation), and AM (amplitude modulation); moreover, communication methods adopted by the connected port D2 of the main receiver D and the connected port E2 of the GPS receiver E to transmit signals include wired signal connector transmission methods employed by RS-232 (Recommended Standard-232, asynchronous serial communication port), and USB (Universal Serial Bus).

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional method for measuring vehicle tire pressure.

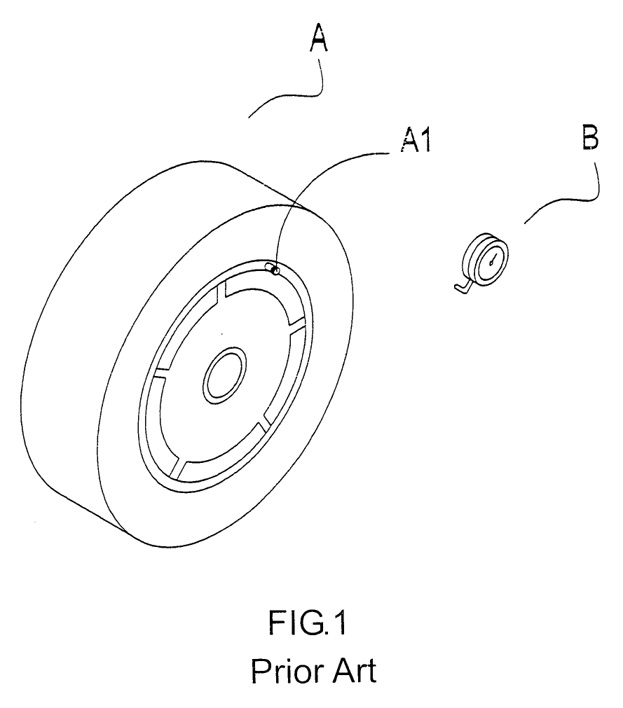

FIG. 2 shows a schematic elevational view according to the present invention.

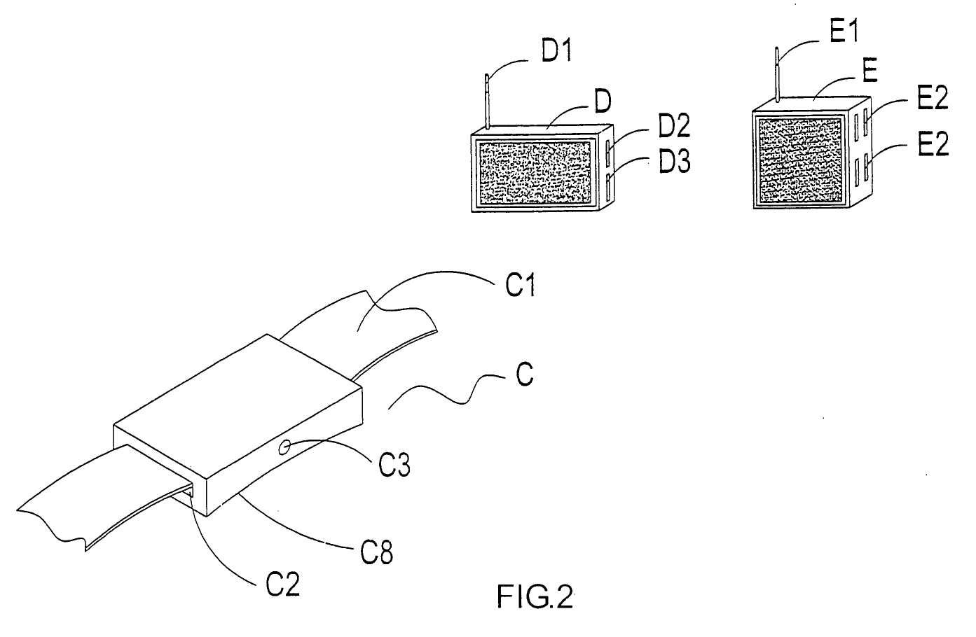

FIG. 3 shows a cross-sectional elevational view of a sensor according to the present invention.

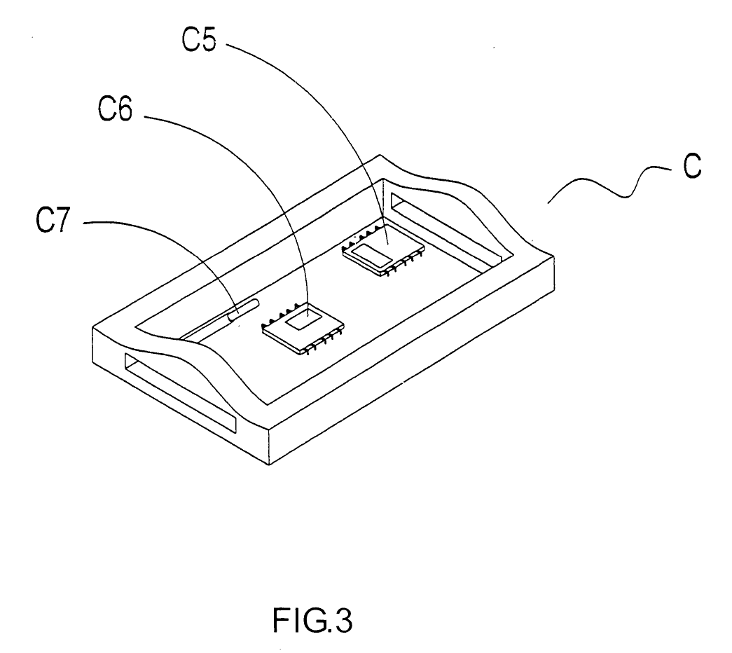

FIG. 4 shows a flowchart of an embodiment according to the present invention.

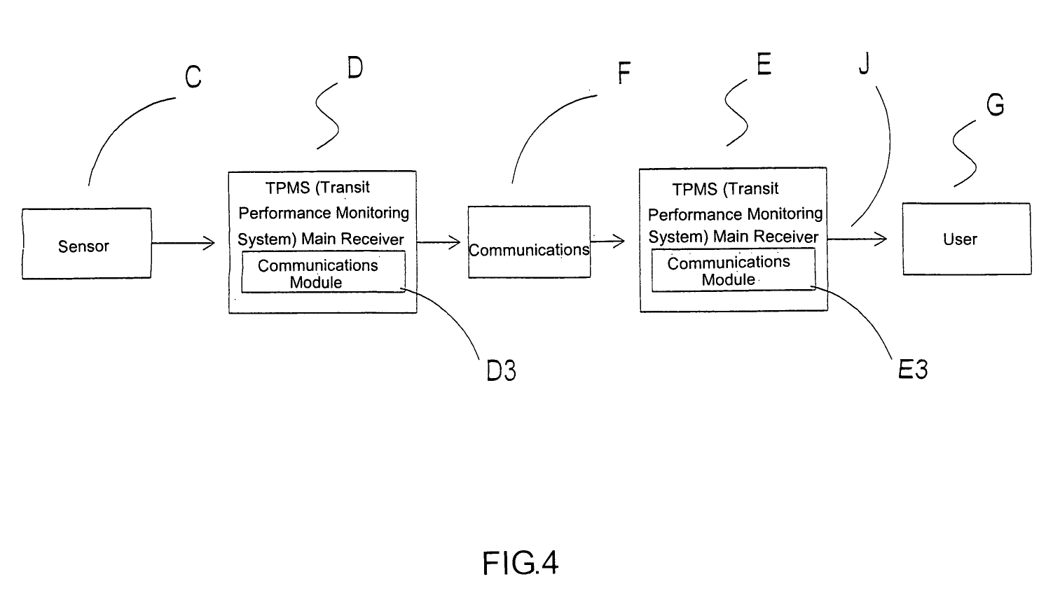

FIG. 5 shows a schematic view of a practical embodiment according to the present invention (1).

FIG. 6 shows a schematic view of a practical embodiment according to the present invention (2).

FIG. 7 shows a schematic view of a practical embodiment according to the present invention (3).

FIG. 8 shows a schematic view of an example of usage according to the present invention (1).

FIG. 8A shows a schematic view of an example of usage according to the present invention (2).

FIG. 8B shows a schematic view of an example of usage according to the present invention (3).

### DETAILED DESCRIPTION OF THE PREFERRED EMBODIMENTS

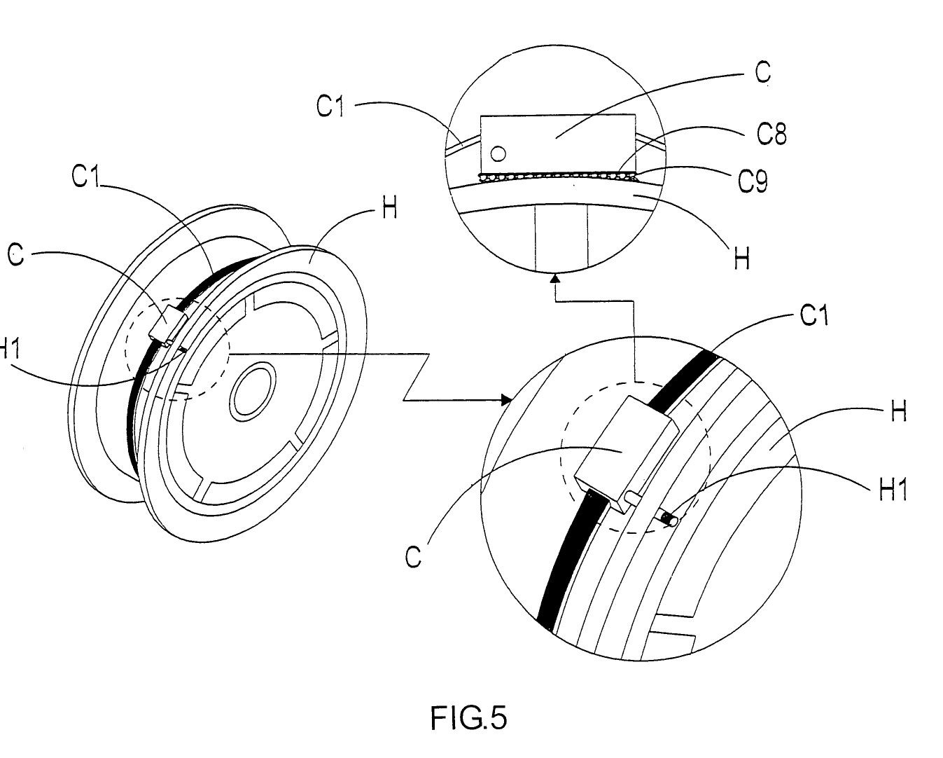

An embodiment of the present invention provides a tire safety monitoring GPS display device, wherein, referring to FIG. 5, a contact surface C8 of a sensor C is joined to a surface of a tire steel ring H by means of a circular fitting fixing agent C9, and an inflation nozzle H1 of the tire steel ring H penetrates a through hole C3 of the sensor C, and after a belt C1 is made to pass through a through hole C2 of the sensor C, the sensor C is thereupon securely fixed onto the tire steel ring H therewith.

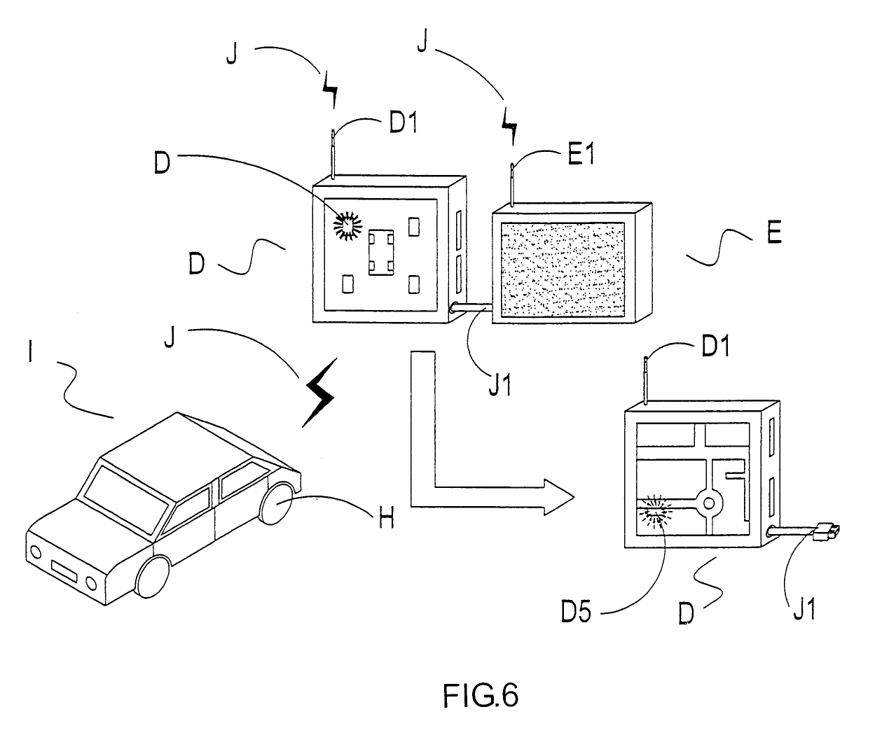

Referring to FIGS. 5 and 6, the sensor C is configured within the tire steel ring H of a vehicle I. During driving of the vehicle I, the sensor C measures data related to pressure change and temperature change interior of vehicle tires at all times, and a wireless signal J carrying the data is transmitted to a main receiver D, whereupon an aerial D1 of the main receiver D receives the wireless signal J and displays on a screen indicator D4 status interior of each tire of the vehicle I, including pressure and temperature. If anomalous phenomena is detected, such as the tire pressure being too high, too low a tire pressure, and so on, then the wireless signal J or a wired signal J1 immediately notifies the GPS receiver E to locate a vehicle repair workshop at a closest distance from the vehicle I, and displays found location on a screen display E4, thereby informing the driver how to proceed towards the vehicle repair workshop in order to service the vehicle I.

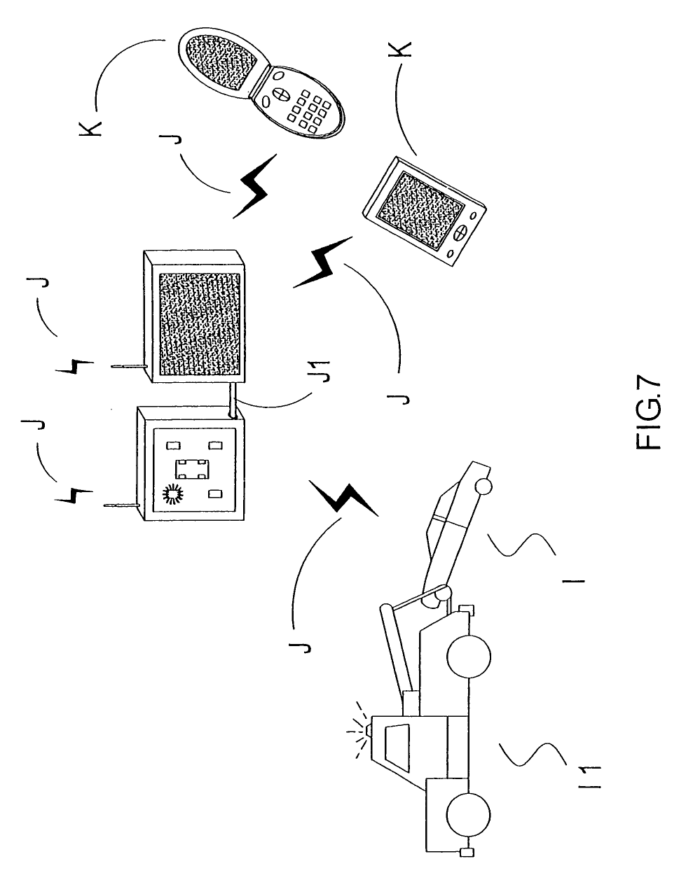

Referring to FIGS. 5 and 7, the sensor C is configured within the tire steel ring H. When the vehicle I happens to be towed away, the sensor C detects that position of the tires have moved, and subsequently transmits a signal to the main receiver D. Upon the main receiver D receiving the signal detecting movement in the position of the tires, a communications module D3 transmits a wireless signal to the GPS receiver E employing a wireless mode from an aerial D1 or transmits wired data to the GPS receiver E employing a wired mode from a connector port D2 according to choice of a user. An aerial E1 correspondingly configured on the GPS receiver E receives the wireless signal from the aerial D1 of the main receiver D or a connector port E2 of the GPS receiver E receives the wired data from the connector port D2 of the main receiver D, and therefrom transmits location of the vehicle I to a mobile phone K or a PDA (Personal Digital Assistant) K1 being used by the user by means of a communications module E3 built into the GPS receiver E that employs communication methods including GPS (Global Positioning System), GPRS (General Packet Radio Service), CDMA (Code Division Multiple Access) or GSM (Global System for Mobile Communications), thereby informing the user that the vehicle has been moved.

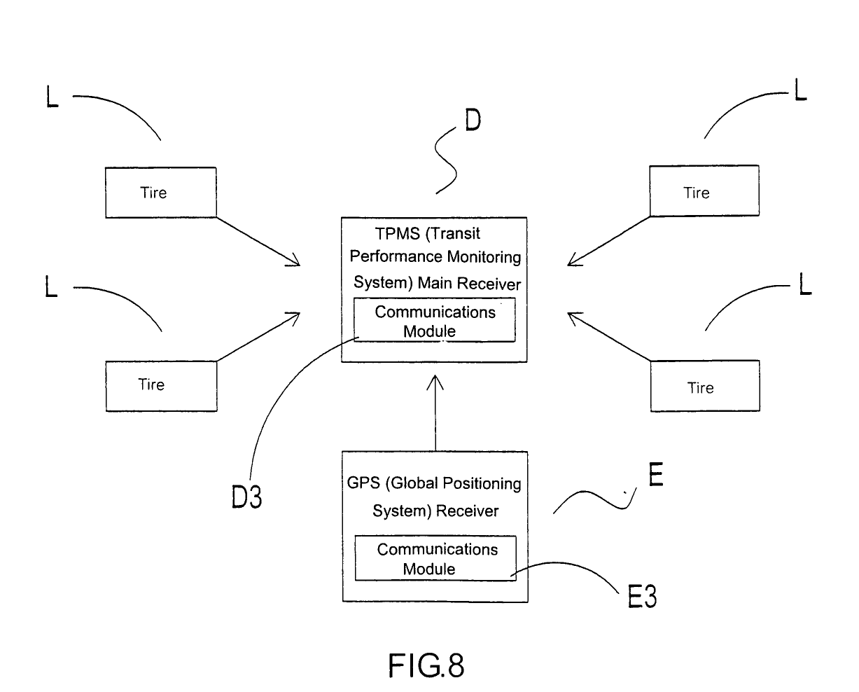

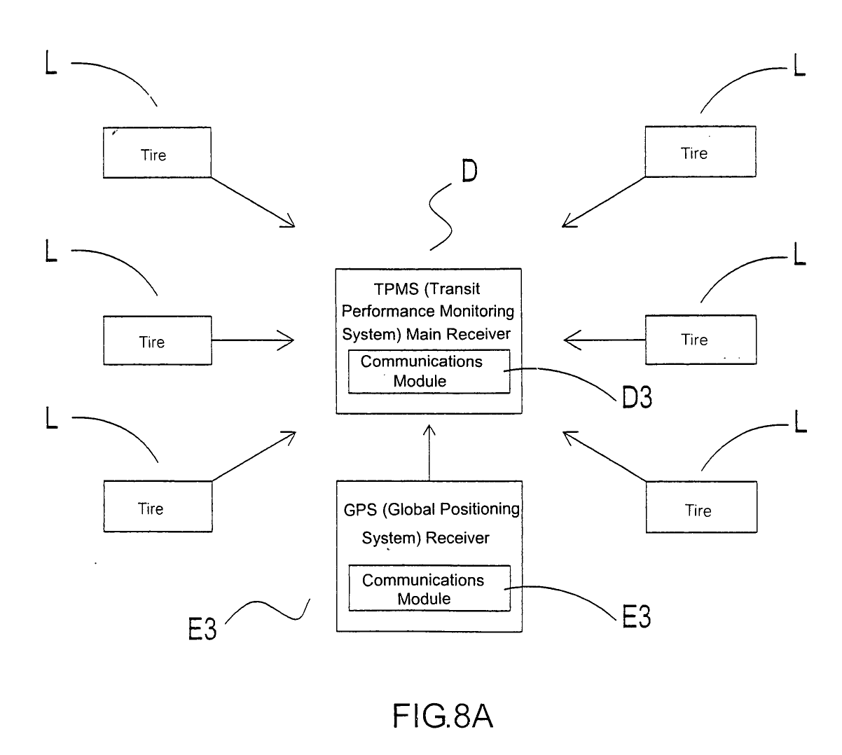

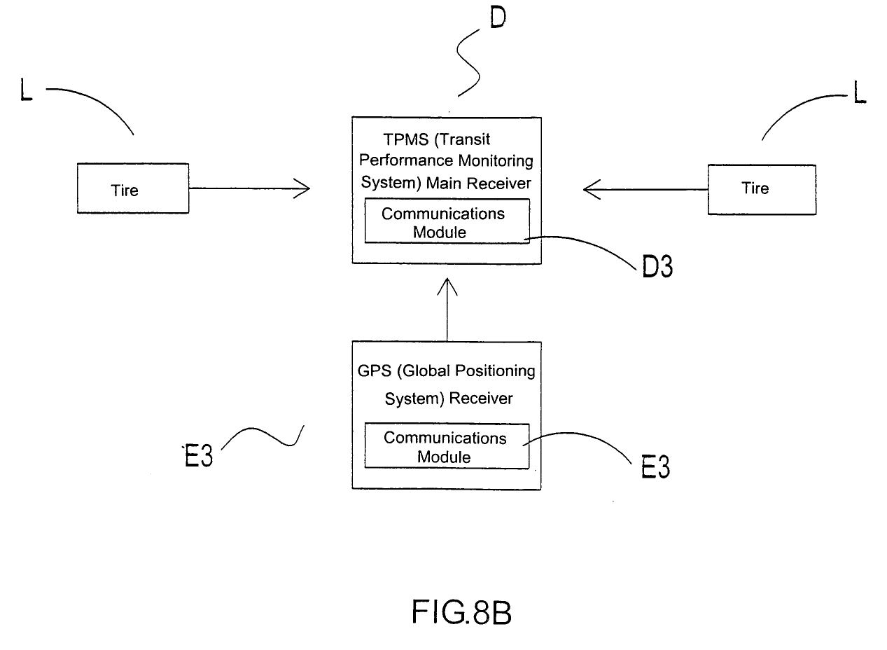

Referring to FIGS. 8, 8A and 8B, which show the main receiver D mutually connected to the GPS receiver E, and mutual communication between the main receiver D and a plurality of sensors C, therewith depicting application of the present invention to various situations, whereby the sensors C are configured in each of the tires of a two-wheeled vehicle, a four-wheeled vehicle and vehicles having a plurality of wheels, thus achieving simultaneous detection of information related to status of pressure and temperature interior of tires L, and thereby notifying the driver of any anomalies within the tires L at all times.

In order to better explicitly disclose advancement and practicability of the present invention, a comparison with conventional art is described hereinafter:

Shortcomings of Conventional Art

1. Inability to measure tire status in real-time.

2. Inability to report tire status in real-time

3. When measuring vehicle tire pressure and temperature, the vehicle must be first stopped before measurement can be carried out.

4. The user must locate a tire inflation station themself.

Advantages of the Present Invention

1. Ability to measure tire status in real-time.

2. Ability to report tire status in real-time.

3. Vehicle tire pressure and temperature can be measured while the vehicle is still being driven.

4. Real-time notification to the user of a station providing air inflation equipment at a closest distance from the vehicle.

5. Upon the vehicle being moved, immediate notification is transmitted to owner of the vehicle.

6. Provided with advancement, practicability and safety.

7. Enhances commercial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A tire safety monitoring GPS display device comprising a sensor, a belt, a main receiver and a GPS (Global Positioning System) receiver, wherein an aerial, a sensor circuit and a transmitting circuit are configured on a circuit board interior of the sensor; and is structurally characterized in that:
a contact surface of the sensor is joined to a surface of a tire steel ring by means of a circular fitting fixing agent, and an inflation nozzle of the tire steel ring penetrates a through hole of the sensor, and after the belt is made to pass through a through hole of the sensor, the sensor is thereupon securely fixed onto the steel ring of a tire therewith, moreover, an arc-shaped form of the contact surface is utilized to effectuate tight adhering of the sensor to a surface of the tire steel ring;
when the sensor circuit interior of the sensor detects internal status of a tire, the transmitting circuit transmits data to the aerial, and thereon a wireless signal carrying the data is transmitted to the main receiver, whereupon status regarding the pressure and temperature interior of the tire is displayed on a screen of the main receiver; if an anomaly occurs, a communications module transmits communication to the GPS (Global Positioning System) receiver, at which time the GPS receiver displays on a monitor a car repair workshop at a closest distance from vehicle, furthermore, if unusual movement in position of the vehicle occurs, the sensor transmits a signal to the main receiver, and upon the main receiver receiving the signal, the communications module transmits communication data to the GPS receiver, and a communications module built into the GPS receiver employs wireless communications technology to transmit location of the vehicle to a mobile communications device used by a user.

2. The tire safety monitoring GPS display device according to claim 1, wherein the main receiver and the GPS receiver further adopt wireless signal transmission technology employed by Bluetooth, FM (frequency modulation), AM (amplitude modulation), and related wireless signal transmission technology to transmit signals therewith.

3. The tire safety monitoring GPS display device according to claim 1, wherein a connector port of the main receiver and a connecter port of the GPS receiver further adopt wired signal connection transmission technology employed by RS-232 (Recommended Standard-232, asynchronous serial communication port), USB (Universal Serial Bus), and related wired signal connection transmission technology to transmit signals therewith.

4. The tire safety monitoring GPS display device according to claim 1, wherein the sensor and the main receiver further adopt wireless signal transmission technology employed by Bluetooth, FM (frequency modulation), AM (amplitude modulation), and related wireless signal transmission technology to transmit signals therewith.

5. The tire safety monitoring GPS display device according to claim 1, wherein the communications module of the GPS receiver further adopts wireless signal transmission technology employed by GPS (Global Positioning System), GPRS (General Packet Radio Service), CDMA (Code Division Multiple Access) or GSM (Global System for Mobile Communications), and related wireless signal transmission technology to transmit signals therewith.
